(19) United States
(12) Patent Application Publication
(10) Pub. No.: US 2012/0113093 A1
(43) Pub. Date: May 10, 2012

(54) MODIFICATION OF PERCEIVED DEPTH BY STEREO IMAGE SYNTHESIS

(75) Inventors: Huei-Hung Liao, San Marino, CA (US); Chang Yuan, Vancouver, WA (US); Hao Pan, Camas, WA (US)

(73) Assignee: SHARP LABORATORIES OF AMERICA, INC., Camas, WA (US)

(21) Appl. No.: 12/942,552

(22) Filed: Nov. 9, 2010

(51) Int. Cl. G06T 15/00

(52) U.S. Cl. 345/419

(57) ABSTRACT

A method for modifying a pair of stereoscopic images for presentation on a display includes receiving the pair of stereoscopic images. Modifying different regions of at least one image of the pair of stereoscopic images in a manner such that the disparity of the different regions is changed. The modifying is selectable by a viewer among at least three different amounts of the disparity.

### CROSS-REFERENCE TO RELATED APPLICATIONS

Not applicable.

### BACKGROUND OF THE INVENTION

The present invention relates generally to displaying stereoscopic images on a display.

Three dimensional capable display devices, such as three dimensional capable televisions, display a stereoscopic image pair to induce in the viewer the sense of perceiving depth. Based on factors such as, for example, age and personal tastes, different viewers have varying degrees of preference or tolerance, for viewing stereo content. Some viewers prefer a large range of depth where the stereo content being displayed appears to span a large depth range distance both in front of and behind the display surface. While a large depth range may be desirable for some viewers, such a large depth range sometimes causes significant discomfort or even nausea for others, who might very likely find a relatively small depth range of perceived depth much more acceptable. Similarly, some viewers tend to prefer a large depth range of perceived depth as opposed to a relatively small depth range of perceived depth.

The significant potential divergence in the viewer's preferences of a suitable depth range for a three dimensional display is problematic with content being provided with only a pre-defined fixed depth range. In many cases, three dimensional stereo content is distributed as is, frequently on physical digital video discs or through digital channels (e.g., a computer, a network, the Internet), where the viewers are not capable of effectively altering the range of depth being displayed for his personal preferences.

Since the perception of depth is inversely related to the disparity value on each pixel between the two images in a stereo pair, the disparity value is altered in order to adjust the perceived depth. To modify the perceived depth, the same constant lateral offset can be added to every pixel in one image of a stereoscopic pair, effectively shifting that entire image by the same pixel distance. In other words, let d(p) be the original disparity value for any given pixel p in one image of the original stereo pair, and d′(p) be the modified disparity value after applying the offset. Accordingly, this results in d′(p)=d(p)+α (Equation 1) where α is the constant offset which is the same across the entire image. Such a technique adds to or subtracts from the disparity between the stereo pair in a uniform fashion without regard to any spatial variation of disparity values in different regions of the images.

The disparity values typically vary significantly across the image. Through the inverse relationship between the disparity and the perceived depth, the spatial variation in disparity in different regions of the image encodes information regarding the underlying scene geometry. The application of a constant lateral offset disregards this spatial variation in disparity for different parts of the image and tends to introduce additional distortion in the image geometry.

Referring to FIG. 1, the eyes 20 of the viewer observe a display surface indicated by a horizontal bar 22. The left scene has the correct depth perception and therefore the correct scene geometry indicated by a square 24. In the right scene, the square 26 indicates the correct scene geometry, while the distorted box 28 illustrates the distorted perceived geometry of the square 24, as a result of applying the same later offset to the entire image. In this case, the right eye image is being shifted uniformly towards the left eye image, compressing the range of depth.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1 illustrates an image with correct depth perception and the same image with incorrect depth perception.

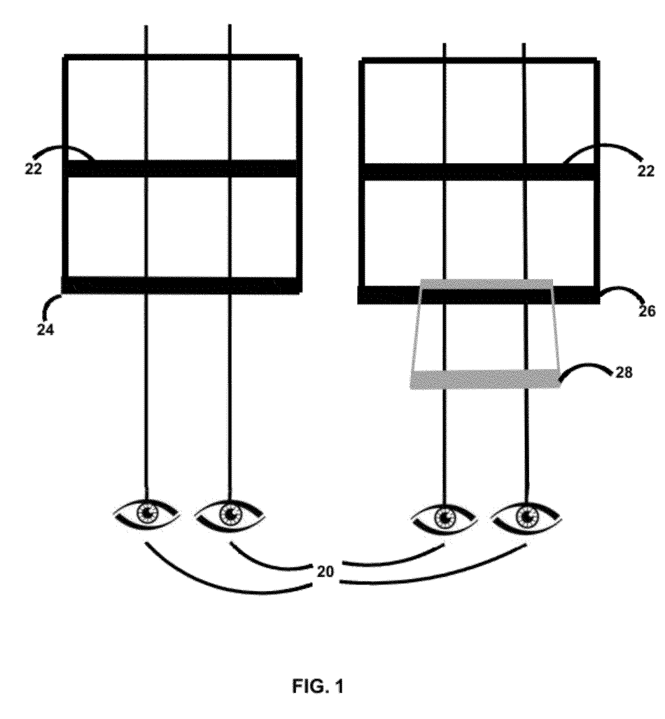

FIG. 2 illustrates a system flow chart.

FIG. 3 illustrates new view synthesis.

FIG. 4 illustrates different camera views.

FIG. 5 illustrates two pass image inpainting.

FIG. 6 illustrates a function of φ(N).

FIG. 7 illustrates reduction of grid quantization artifacts.

### DETAILED DESCRIPTION OF PREFERRED EMBODIMENT

Different viewers of a display tend to have different preferences for the perceived depth of stereoscopic content. To achieve a more suitable view for a particular viewer, the system should include a set of viewer selectable depth ranges that may be displayed to the viewer. The adjustment may be selected using any technique, such as for example, an on-screen menu on the display, a remote control, a selection on a pair of stereoscopic glasses, or an automatic setting selected by the stereoscopic glasses. One or both of the images used for such a stereographic content should be adjustable in a more continuous manner, or otherwise with a substantial number of settings (such as 3 or more), by synthesizing one or both views according to the viewers' personal preference. The viewers settings are not limited to a single fixed number such as 0.5, but rather are preferably selectable among a broad range of values, such as 10 or more settings. The technique preferably generates a “continuous range” of adjusted depth images by synthesizing one or more new views according to the viewer's preferences. The technique should also compress or expand the disparity in a manner that preserves the underlying scene geometry.

Rather than applying a uniform offset indiscriminately across the entire image as in Equation 1, the scene geometry aware technique should scale the disparity value on the pixels in the image by a factor that is adjustable by the viewer. One scaling technique is to select the modified disparity value d′(p) to be d′(p)=ρ·d(p) (Equation 2), where ρ is a scale factor or any other function. By using a scaling technique rather than merely an offsetting technique, the system is more capable of preserving the spatial variation of the disparity across the entire image by ensuring that the ratio between different disparity values on different pixels remains substantially unchanged. The scaling technique may likewise include an offset, if desired. Other techniques that modify the disparity that are based, at least in part, on scene geometry may likewise be used.

Applying a scaling technique to neighboring pixels having different disparity values results in different amounts of lateral offsets for the different neighboring pixels. Unfortunately, the difference in lateral offsets of neighboring pixels results in holes in the newly synthesized image. To fill in the newly created holes in the synthesized image any suitable technique may be applied to fill in the hole areas. On suitable technique for filling in the holes is an in-painting technique that models the surrounding intensity values around a particular hole and fills the hole by inward propagation. Unfortunately, with a stereo image pair, a solely appearance-based in painting technique tends to produce suboptimal results since the disparity information is not taken into account.

To provide in-painting of the holes in the synthesized image created as a result of scaled offsets should, in addition to using local intensity values, model the local disparity values and local geometric saliency. In particular, the technique may split and separately process the low frequency parts and the high frequency parts of the stereo image pair during the view synthesis. This separation of different regions of the leads to more reliable and visually pleasing results.

The technique may further eliminate grid quantization artifacts that are a result of the inherently discrete, or quantized, nature of disparity values, where a given pixel is only allowed to assume an integer lateral offset number. This may be done by adaptively filtering the synthesized virtual view in a small neighborhood where such artifacts are detected. By restricting the filtering to a small neighborhood, the technique reduces the artifacts while preserving the details in the synthesized view, without introducing excessive undesirable blurring.

To summarize, based on the original stereo image pair, the technique preferably generates a “continuous range” (e.g., three or more) of interpolation as well as extrapolation of new view points with adjusted depth, according to a viewer's preference. By employing scaling of disparity values, rather than constant offsetting, this preserves the spatial variation of disparity (inverse depth) across the image, which in turn preserves the underlying scene geometry (depth). Also, by synthesizing a new view using local image intensity values, disparity values, and geometric saliency information, as opposed to relying only on intensity further refines the synthesis process by separately processing the low and high frequency content in the stereo pair. Further, the reduction of grid quantization artifacts in a local manner also preserves details and reduces blurring the synthesized virtual view.

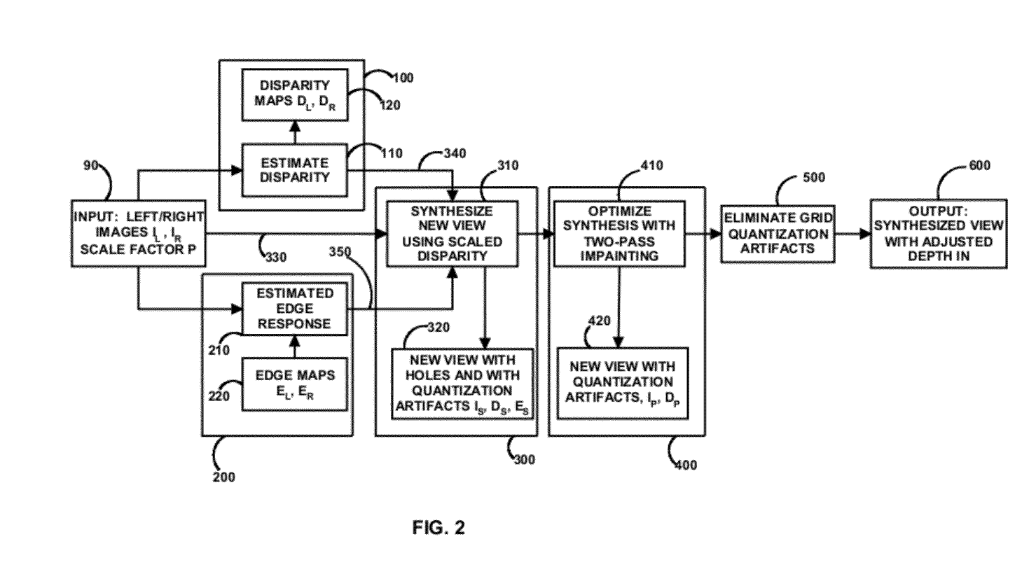

Referring to FIG. 2, the technique may be described in terms of five primary components, namely, disparity estimation 100, edge response 200, synthesize view 300, view optimization 400, and grid quantization 500. The technique receives a rectified pair of stereo images I_{L}, I_{R} as input 90. The technique may likewise operate with non-rectified pairs of stereo images or otherwise rectify received pairs of stereo images. The disparity estimation component 100 estimates the disparity value of each pixel 110 both from the left image to the right image in D_{L} 120, and from the right image to the left image in D_{R} 120.

The technique estimates the edge response 200, preferably simultaneously (during the same time as) with the disparity estimation 100, of the two images 220, E_{L} and E_{R}, by computing the magnitude of gradient response along the horizontal and the vertical directions 210. The gradient response provides information on salient local geometric structures, which guides the synthesis process described later. The synthesize view 300 then synthesizes 310 the new view I_{S} 320, the new reference disparity map D_{S} 320, and the new edge map E_{S} 320 by scaling the original disparity D_{L} and D_{R} 120 with a user-selectable scale factor ρ and by laterally shifting each pixel in the original images I_{L} and I_{R} 330 accordingly. Since the technique performs disparity scaling, rather than constant offsetting, holes 320 are created in the synthesized view I_{S}, as well as in D_{S} and E_{S}. The view optimization 400 may employ a one or a two-pass, depth-assisted inpainting approach 410 to optimize the synthesis by filling in the holes, producing a complete 420 (i.e. no-holes) new view I_{P} and a complete reference disparity map D_{P}. The grid quantization 500 technique reduces grid quantization artifacts introduced by the inherently discrete levels that disparity values are limited to. The technique reduces such quantization artifacts from I_{P} and produces the final output I_{N} 600 as the synthesized new view with adjusted depth.

The disparity estimation 100 may employ any suitable technique to estimate the disparity to compute D_{L} and D_{R}. By way of convenience, the disparity values may be computed for a rectified stereo pair by subtracting the x-coordinate of a pixel in the left-eye image from the x-coordinate of its corresponding pixel in the right-eye image (and vice versa). Therefore, the following relationships may be expressed for non-occluded pixels, I_{R}(x+D_{L}(x,y),y)=_{L}(x,y) (Equation 3) as well as I_{L}(x−D_{R}(x,y),y)=I_{R}(x,y) (Equation 4).

The edge response 200 may be estimated 210 for the left-eye and right-eye image 220 in the input stereo pair by combining the gradient response in the image x-direction (horizontal) and the image y-direction (vertical). More

$$\begin{matrix}{E}_{L} = {[ {( \frac{d {I}_{L}}{d x} )}^{2} + {( \frac{d {I}_{L}}{d y} )}^{2} ]}^{\frac{1}{2}} and & ( Equation 5 ) \\ {E}_{R} = {[ {( \frac{d {I}_{R}}{d x} )}^{2} + {( \frac{d {I}_{R}}{d y} )}^{2} ]}^{\frac{1}{2}} . & ( Equation 6 )\end{matrix}$$

specifically,
The two first-order partial image derivatives may be calculated by convolving the images I_{L} and I_{R} with a kernel of the form

$$\vert \begin{matrix}- 1 & - 2 & - 1 \\ 0 & 0 & 0 \\ 1 & 2 & 1\end{matrix} \vert$$

for the x-direction, and

$$\vert \begin{matrix}- 1 & 0 & 1 \\ - 2 & 0 & 2 \\ - 1 & 0 & 1\end{matrix} \vert$$

for the y-direction.

The synthesize view 300 receives input stereo images I_{L}, I_{R} 330 (which are assumed to be rectified), disparity maps D_{L}, D_{R} 340, and edge maps E_{L}, E_{R} 350, the technique proceeds to synthesize a new view with the desired depth (disparity) according to the shift factor ρ that is specified by the user, according to his or her preference.

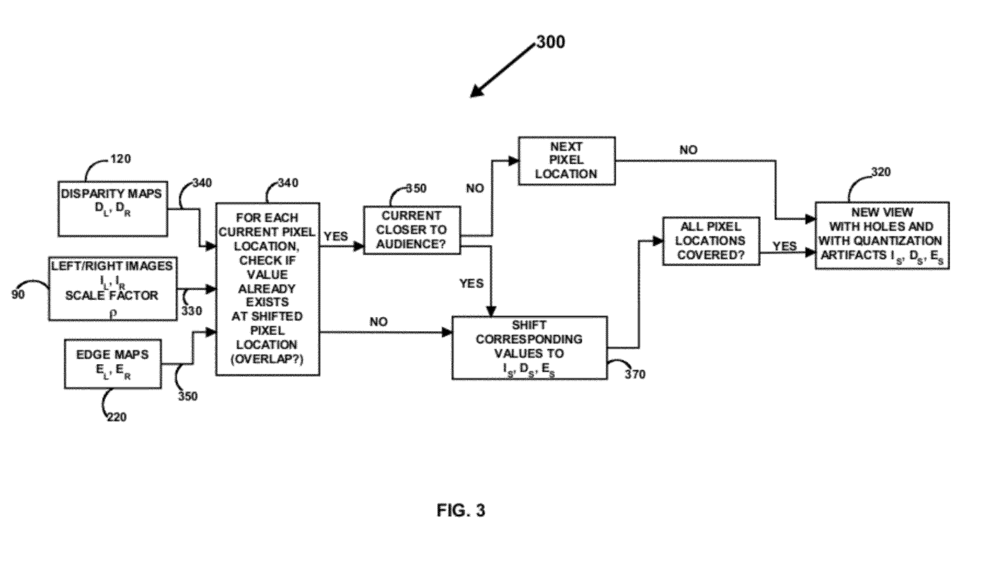

Referring also to FIG. 3, a more detailed embedment of the synthesize view 300 is illustrated. The technique processes each pixel in I_{L} and I_{R} 300, and shifts them to create the new view I_{S} 320. The amount of shift is jointly determined by the shift factor ρ 330 and the information in D_{L} and D_{R} 340. More specifically, let I_{L}(x,y) denote the intensity value of a pixel p at (x,y) in the left-eye image, as indicated by its subscript, and let D_{L}(x,y) denote its disparity value. For all the pixels in the left-eye image results in I_{S}(x+ρ·D_{L}(x,y),y)=I_{L}(x,y) (Equation 7). Similarly, for all the pixels in the right-eye image results in I_{S} (x−(1−ρ)·D_{R} (x,y),y)=I_{R} (x,y) (Equation 8).

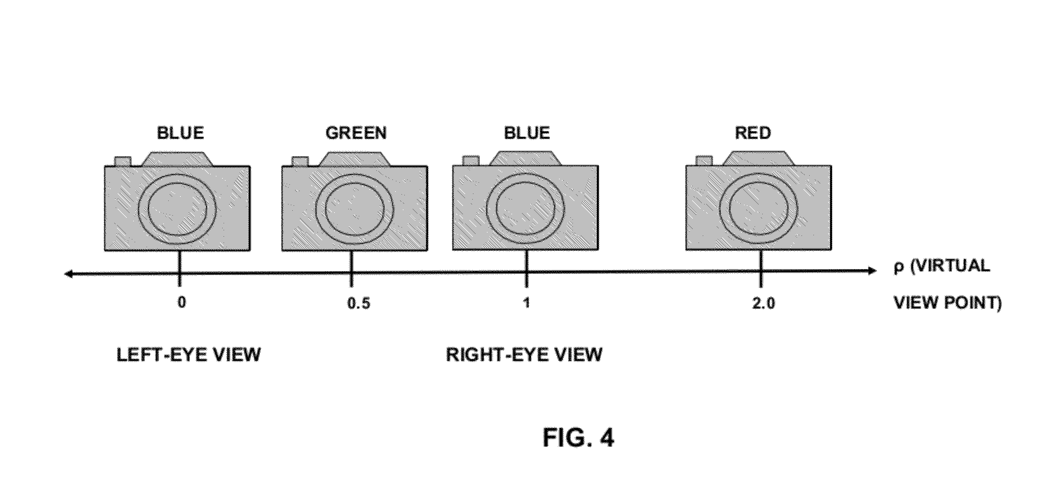

It is noted that for a p value of 0, Equation 7 degenerates into I_{L}(x,y) itself, while Equation 8 degenerates into Equation 6, also resulting in I_{L}(x,y). For a ρ value of 1, Equation 7 degenerates into Equation 5, resulting in I_{R}(x,y), while Equation 8 also degenerates into I_{R} (x,y) itself. This symmetrical property follows from the definition of disparity and leads to the notion of interpolation and extrapolation of virtual view points on a linear disparity scale defined by varying p, as is illustrated in FIG. 4.

One subtlety may be addressed to improve the view synthesis. From the above definition, on occasion multiple pixels in I_{L} and/or I_{R} may be shifted to the same pixel location in I_{S} 340. When such situations arise, the technique resolves the ambiguity by selecting objects closer to the audience shall always occlude objects farther away 350. With this definition of disparity, this translates to objects with smaller disparity (possibly negative) should occlude objects with larger disparity when they overlap (possibly negative). Therefore, in the case of a pixel overlap, the technique selects the pixel from the object closest to the audience (i.e. having smallest disparity).

D_{S} and E_{S} are synthesized 370 in the same manner from D_{L}, D_{R} and E_{L}, E_{R}, respectively, as I_{S} is from I_{L} and I_{R}. D_{S} may be the reference disparity map for the newly synthesized view, and its pixels have the same value as their corresponding pixels in D_{L} and D_{R}. For this reason, D_{S} is no longer a disparity map in the term's strictest sense, as its pixel values do not reflect the newly adjusted depth (disparity) of the synthesized view. Rather, D_{S} is used in later stages of the technique to compute the similarity measure in the inpainting process (detailed below). D_{S} therefore is referred to as a reference disparity map, rather than a disparity map.

With I_{S}, D_{S}, and E_{S} defined, Equations 7 and 8 may be modified to incorporate the handling of possible pixel overlaps when synthesizing I_{S} D_{S}, and E_{S}. Initially, pixels in D_{S} are set to a maximum possible value. It is then continuously updated as the technique successively processes every pixel in I_{L}, and I_{R}, D_{L} and D_{R}, E_{L} and E_{R}. Since D_{S}(x,y) should record the smallest disparity value on that pixel location, the order in which different pixels in the left-eye and right-eye images are processed is irrelevant.

For the left-eye image I_{L}, I_{S} may be characterized as a general equation I_{S}(x+ρ·D_{L}(x,y),y)=H·I_{S}(x+ρ·D_{L}(x,y),y)+(1−H)·I_{L}(x,y) (Equation 9) where

$$H = \{ \begin{matrix}1 if {D}_{S} ( x + ρ \cdot {D}_{L} ( x , y ) , y ) \leq {D}_{L} ( x , y ) \\ 0 if {D}_{S} ( x + ρ \cdot {D}_{L} ( x , y ) , y ) > {D}_{L} ( x , y ) .\end{matrix}$$

Similarly, for the right-eye image I_{R}, I_{S} I_{S}(x−ρ·D_{R}(x,y),y)=H·I_{S}(x−ρ·D_{R}(x,y),y)+(1−H)·I_{R} (x,y) (Equation 10) where

$$H = \{ \begin{matrix}1 & if {D}_{S} ( x - ρ \cdot {D}_{R} ( x , y ) , y ) \leq {D}_{R} ( x , y ) \\ 0 & if {D}_{S} ( x - ρ \cdot {D}_{R} ( x , y ) , y ) > {D}_{R} ( x , y ) .\end{matrix}$$

As previously described, in order to preserve the spatial variation of disparity (and thus the scene geometry) across the image by ensuring the ratio is substantially unchanged between different disparity values on different pixels (or any general regions), the system may scale the disparity values rather than uniformly offset them. This introduces holes in the newly synthesized virtual view point represented by I_{S}, D_{S}, and E_{S}, as the relative foreground and background are shifted by differing amounts of offset, depending on their original disparity and the shift factor ρ.

To reliably fill the holes and produce a convincing, realistic result, the system should specifically target the image inpainting for a stereo setting, taking into account the available depth (disparity) information, the local geometric saliency, as well as intensity information. To provide a more versatile and more universally applicable technique, the system should impose no constraint on and assume no knowledge of the camera parameters. In other words, for better generality, the technique should adopt an image-based stereo inpainting framework, rather than calibration-based.

The inpainting technique may be linear or non-linear. Such linear techniques may include, for example, scanline interpolation and extrapolation. Such linear techniques tend to be computationally efficient, and tend to be robust when intensity variations are low (low frequency) in an image region requiring inpainting. Such non-linear techniques tend to be more computationally complex, and may include for example, partial differential equations or utilize exemplars in filling holes. In high-intensity-variation regions (high frequency content), however, linear techniques tend to produce significant blurring and other noticeable artifacts. Non-linear techniques, such as an exemplar-based one, are more suitable to prefer high frequency details without blurring and noticeable artifacts.

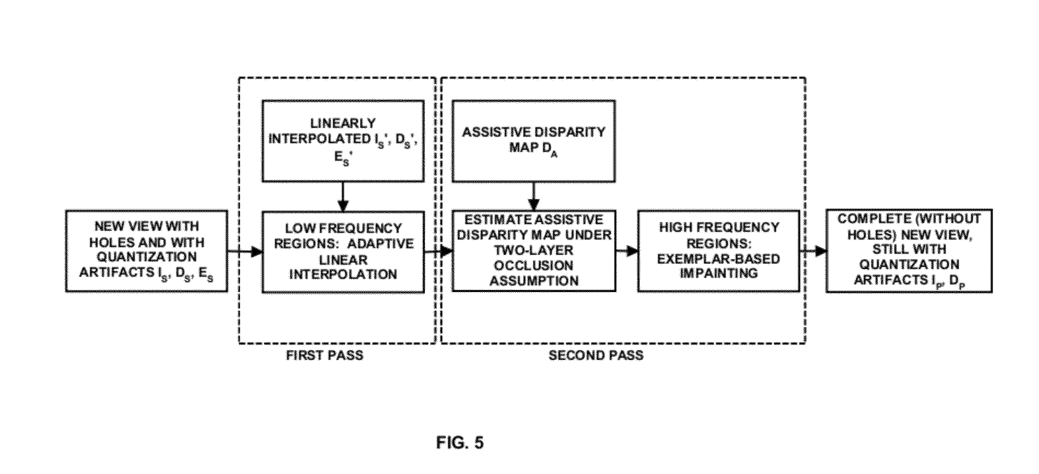

Referring to FIG. 5, with different techniques more suitable for different types of content (low frequency and high frequency), where natural images typically exhibit both types of content, a hybrid framework facilitates the inpainting for both cases. The first pass fills holes in low-frequency image regions using a first filter, such as an adaptive linear interpolation, and afterwards the second pass processes high-frequency image regions using a second filter, such as a non-linear exemplar-based inpainting.

During the first pass for low frequency inpainting, the holes in a low-frequency image region in I_{S} are typically surrounded by pixels that are similar in intensity values as well as in disparity values. On a single scanline, a hole is represented as a succession of empty pixels of length γ. If the two non-empty pixels at the two ends of γ are similar in intensity and disparity, and if the length γ is reasonably small, then the intermediate empty pixels (hole) are filled by interpolating the two pixels at the ends will likely produce a visually cohesive result. Here, the length γ becomes a parameter that not only has to be selected but also is expected to vary from one image to the next. In order to automate the parameter selection, an adaptive linear interpolation that dynamically changes the effective γ as the technique progresses within each scanline in I_{S} may be used.

Specifically, the low-frequency inpainting technique takes a single fixed γ_{M} as the input parameter, and allows holes of any intermediate length γ between 0 and γ_{M} to be interpolated. For any empty pixel (hole pixel) h on a single scanline, the technique computes the entire length of the hole that h belongs to as γ(h). Note that h can be any point along the hole length γ(h), and any point that belongs to the same hole as h has the same γ(h). The technique also records the two non-empty pixels at the ends as head(h) and tail(h). If 0<γ(h)≦γ_{M}, the empty pixel h may be interpolated as

$$h = head ( h ) + [ x ( h ) - x ( head ( h ) ) ] \cdot \frac{tail ( h ) - head ( h )}{γ ( h )} \qquad ( Equation 11 )$$

where x indicates the x-coordinate of a pixel. Otherwise, h is left empty. D_{S} and E_{S} are interpolated in the in the same manner as I_{S}. Following the same naming convention, one may label the intermediate output from the first-pass inpainting as I_{S}′, D_{S}′, and E_{S}′. Using γ_{M} as the maximum length eliminates the problem of having to specify holes of what length are interpolated and holes of what length are not. A conservative choice for γ_{M} ensures the robustness and reliability of this approach. Preferably, γ_{M} is chosen to be between 6 and 12. Also, the first-pass low-frequency inpainting is performed across horizontal scanlines as well as vertical scanlines.

The second pass of inpainting addresses high-frequency content in the image, filling pixels that are left unprocessed (left empty) by the first pass in I_{S}′, D_{S}′, and E_{S}′. In order to preserve high-frequency details, the technique may employ a non-linear exemplar-based approach to synthesize the remaining holes. Since an exemplar-based inpainting relies both on intensity similarity and disparity similarity in evaluating a matching cost, the technique may make an explicit assumption regarding occlusion. For example, the technique may assume all occlusions in the stereo image pair to be two-layer occlusions. Except for complicated scenes where there is sophisticated interaction between multiple layers of objects, in most cases this simplifying assumption is valid. Under the assumption, a hole in I_{S}′, D_{S}′, and E_{S}′ can be assumed to be caused by disocclusion between a foreground object and a background object, and therefore the newly exposed image region (which is the hole) should belong to the background object. An assistive disparity map D_{A} based on D_{S}′, may be created by artificially filling in each hole in D_{S}′ with the largest disparity value (background object) in its local neighborhood. For an empty pixel h in D_{S}′, D_{A} may be generated using the following equation: D_{A}(h)=max_{i,jε(-w,w)})(D_{S}′(x(h)−j,y(h)−i)) (Equation 12) where 2w is the window size around h's local neighborhood, which is set slightly larger than the largest hole. As with D_{S} and D_{S}′, D_{A} is not a disparity map in the term's strictest sense, but it represents an estimate regarding depth information in the disoccluded regions, or holes, and it may be used to assist the exemplar-based inpainting process.

For the exemplar based inpainting process, one may refer to the set of all empty pixels in I_{S}′ as θ, and to the set of all empty pixels on the boundary of all holes in I_{S}′ as dθ, which is otherwise known as the fill front. Clearly, dθεθ. Let ω_{IS} be a window centered on a given empty pixel on the fill front dθ in I_{S}′. It follows from the definition of dθ that some of the pixels in ω_{IS} are empty while others are not. An exemplar, ω_{I}, on the other hand, is a candidate match, which can be any window of the same size in the original left-eye image I_{L} or right-eye image I_{R}. Similar definitions follow for ω_{IS}'s corresponding ω_{DS} on the same pixel location in D_{A} as ω_{IS} is in I_{S}′ and for ω_{I}'s corresponding ω_{D}, in D_{L}, or D_{R}. Note that in evaluating the best-matching exemplar, the technique may use the estimated assistive disparity map D_{A} to incorporate disparity information into the cost computation. The best-matching exemplar, ω_{IB}, is then found by comparing the (ω_{IS},ω_{DS}) pair with (ω_{I},ω_{D}) at all possible pixel locations in I_{L} and I_{R} using some cost function. In other words, ω_{IB}=arg min_{ω}_{_{I}}_{,ω}_{_{D}}_{εI}_{_{L}}_{,I}_{_{R}}{ƒ((ω_{IS},ω_{DS}),(ω_{I},ω_{D}))} (Equation 13) where ƒ represents the cost function that takes both intensity and depth (disparity) into account. Once the best-matching exemplar is found, the technique copies pixel values from ω_{I} in I_{L} or I_{R} to empty pixels in ω_{IS} in I_{S}′, while leaving existing, non-empty pixels in w unchanged. Empty pixels in θ are filled in an iterative manner, with each iteration processing its current fill front dθ. As the technique proceeds, the number of pixels in θ steadily decrease and dθ shrinks accordingly.

There are two additional aspects that may be included with exemplar-based inpainting, namely, the technique's fill order and the cost function ƒ it uses in determining the best-matching exemplar. Fill order is the order in which different empty pixels on the current fill front dθ get filled. As once an empty pixel is filled, it is removed from θ and becomes part of I_{S}′, influencing subsequent inpainting in its neighborhood. A scheme for computing the optimal fill order, combining a local confidence measure and a local geometric saliency measure. One may adopt an approach to determining the fill order. Specifically, a local confidence measure may be used to reflect how filled a particular ω_{IS} already is, essentially assuming that the more pixels in ω_{IS} that are already filled, the easier (more constrained) it is to fill the remaining empty ones, therefore making this particular ω_{IS} a more certain and attractive target to process early on. On the other hand, local linear structures, or isophotes, provide another source of useful information related to the geometry of a local image region, which, at the same time, also impose strict constraint on the inpainting to be performed. The underlying idea is that as isophotes arrive at a fill front they have to be continued inside the hole. As a result, regions with a high gradient response in E_{S}′ also deserve early attention. A local geometric saliency measure thus reflects this information in E_{S}′. These two measures are sometimes competing and therefore require certain amount of balancing act, which interested readers are encouraged to explore. Taken together, the two measures define the optimal fill order in the high-frequency inpainting.

The other element that may be included in the exemplar-based inpainting is the structure of the cost function ƒ that is used in evaluating the best-matching exemplar. One may explicitly model the intensity similarity as well as the disparity similarity. For the intensity component ƒ_{I} of the cost function ƒ, one may adopt a normalized sum of squared differences (NSSD), as

$${f}_{I} ( {ω}_{IS} , {ω}_{I} ) = \frac{\begin{matrix}{\sum }_{i , j ∈ ( - w , w )} \{ c ( {x}_{IS} + j , {y}_{IS} + i ) \} \cdot \\ \{ {[ {ω}_{IS} ( {x}_{IS} + j , {y}_{IS} + i ) - {ω}_{I} ( {x}_{I} + j , {y}_{I} + i ) ]}^{2} \}\end{matrix}}{{\sum }_{i , j ∈ ( - w , w )} \{ c ( {x}_{IS} + j , {y}_{IS} + i ) \}} \qquad ( Equation 14 )$$

where again 2w is the window size, ω_{IS} is centered on (x_{IS},y_{IS}), and ω_{I} is centered on (x_{I},y_{I}). The function c indicates whether the current pixel in ω_{IS} is empty or not. If it is, it should be ignored by the NSSD computation as empty pixel should not contribute anything to the matching cost. If not, it should then be included in the computation. Specifically,

$$c ( x , y ) = \{ \begin{matrix}0 & if ( x , y ) is an empty pixel in {ω}_{IS} \\ 1 & otherwise .\end{matrix}$$

For the disparity component ƒ_{D} of the cost function ƒ, it may be noted that since ω_{DS} is taken from D_{A}, its values are merely a best estimate under the two-layer occlusion assumption and inherently contains noise. When computing the matching cost for disparity, one may therefore allow a margin of error ε and impose a cap μ for robustness. Specifically,

$${f}_{D} ( {ω}_{DS} , {ω}_{D} ) = \frac{\begin{matrix}{\sum }_{i , j ∈ ( - w , w )} \{ c ( {x}_{DS} + j , {y}_{DS} + i ) \} \cdot \\ \{ ϕ ( {ω}_{DS} ( {x}_{DS} + j , {y}_{DS} + i ) - {ω}_{D} ( {x}_{D} + j , {y}_{D} + i ) ) \}\end{matrix}}{{\sum }_{i , j ∈ ( - w , w )} \{ c ( {x}_{DS} + j , {y}_{DS} + i ) \}} . \qquad ( Equation 15 )$$

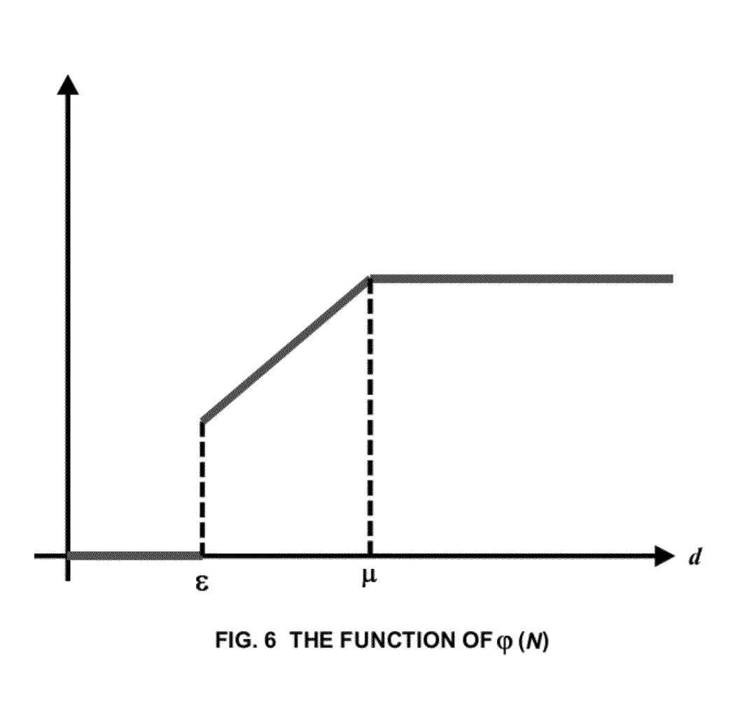

The function φ has a stretched step response and may be expressed as

$$ϕ ( n ) = \{ \begin{matrix}min ( \vert n \vert , μ ) if \vert n \vert > ɛ \\ 0 if \vert n \vert \leq ɛ\end{matrix}$$

where ε is a small positive integer and μ is a larger positive integer. For a typical disparity range of 0 to 200, ε is chosen to be 15 and μ to be 50. The function φ can be seen in FIG. 6.

With the two components of the cost function ƒ properly defined, ƒ itself follows from Equation 14 and 15 and may be given as ƒ((ω_{IS},ω_{DS}),(ω_{I},ω_{D}))=ƒ_{I}(ω_{IS},ω_{I})+k·ƒ_{D}(ω_{DS},ω_{D}) (Equation 16) where the constant k is a normalizing factor bringing the two components to a comparable numerical level. For a typical n-bit image, k is chosen to be

$$\frac{( {2}^{n} - 1 ) \cdot ( {2}^{n} - 1 )}{μ} .$$

The best-matching exemplar ω_{IB}, then, is the exemplar among all others in I_{L} and I_{R} with the lowest cost ƒ in Equation 16, satisfying Equation 13.

The process for high-frequency inpainting described above fills the holes in I_{S}′, generating a complete (no holes) synthesized virtual view, I_{P}. Using the exact same fill order and cost function ƒ, the high-frequency inpainting also generates in a similar fashion a complete reference disparity map D_{P} for the synthesized view, based on D_{S}′.

The first-pass, low-frequency inpainting takes in I_{S}, D_{S}, and E_{S}, and generates I_{S}′, D_{S}′, and E_{S}′. The second-pass, high-frequency inpainting then takes in I_{S}′, D_{S}′, and E_{S}′, and produces I_{P} and D_{P}. The entire process of optimizing view synthesis with two-pass image inpainting is summarized in the flow chart in FIG. 5. Using only low-frequency inpainting leads to significant blurring in high-frequency image regions, whereas using only high-frequency inpainting introduces noisy artifacts in otherwise smooth areas. By employing both methods where they are appropriate, the two-pass inpainting produces a desirable complete virtual view. Since these are I_{P} images, noticeable grid quantization artifacts have yet to be reduced.

With I_{P} and D_{P} thus generated, the system has a complete, synthesized virtual view that is already hole-free. However, noticeable artifacts still exist. These artifacts may be generally referred to as the grid quantization artifacts. To understand the origin of such artifacts, one may re-visit the use of scaled disparity value in synthesizing the new view. For a non-front or parallel surface adjacent pixels have different depths and therefore should have different disparity values. These different disparity values are still different after applying a non-zero shift factor ρ. As a result, adjacent pixels on a slanted surface may have different lateral offsets. In synthesizing the new view, this may create a void in between the adjacent pixels. If this void stays empty, it becomes a hole and will be processed by the two-pass inpainting process. If, however, a pixel from another background objects with a certain offset falls on this void, a visually noticeable artifact is created. This phenomenon may be referred to as a grid quantization artifact to reflect the inherently discrete, or quantized, nature of disparity values, where a pixel can only assume an integer number of lateral offset.

These artifacts are easily noticeable to human eyes as the foreground object is split up and the background object erroneously shows through seams. Since in the real world the foreground and background objects can assume any possible combination of intensity values, there is no universally reliable way to model the artifacts using intensity information. Fortunately, the artifacts manifest themselves in the inpainted reference disparity map D_{P}. Thin lines of background disparity values that are sandwiched between foreground disparity values are indication of occurrence of the grid quantization artifact in the local neighborhood.

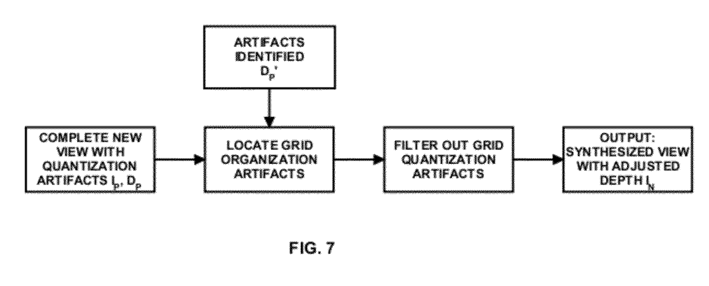

The process to eliminate the artifacts is summarized in the FIG. 7 First identify the locations of an artifact by examining the reference disparity map D_{P}. For a pre-determined maximum seam width of σ, a pixel p(x,y) in D_{P} is considered an artifact pixel if the following statement evaluates to true Uᵢ₌₁^{σ}{[|D_{P}(x−i,y)−D_{P}(x+σ−i+1,y)|≦d_{σ}]∩[D_{P}(x,y)−d_{M}>d_{σ}]} (Equation 17) where d_{M}=max[D_{P}(x−i,y),D_{P}(x+σ−i+1,y)].

Here, d_{σ} is a given threshold that establishes (dis-)similarity between disparity values, which is typically chosen to be 10 to 20, out of a common disparity range of 0 to 200. This is to say that a pixel p(x,y) is an artifact pixel if and only if, for a short line segment of length σ containing p(x,y), the two bounding pixels at the ends have very similar disparity and the maximum of the end disparities is significantly smaller (foreground) than the disparity at p(x,y) (thus background). It should be noted that for reasonable extrapolation of view point by one or two multiples of baseline, a σ value of 2 yields good performance. For smaller extrapolation or interpolation of view point, a value of 1 should suffice.

With knowledge of the locations of artifacts, the technique proceeds to filter out the artifacts. Specifically, for a pixel p(x,y) that is identified as an artifact pixel,

$${I}_{N} ( x , y ) = {I}_{P} ( x - {i}_{s} , y ) + ( \frac{{i}_{s} + 1}{σ + 1} ) \cdot [ {I}_{P} ( x + σ - {i}_{s} + 1 , y ) - {I}_{P} ( x - {i}_{s} , y ) ] \qquad ( Equation 18 )$$

where i_{S} is the smallest i that causes Equation 17 to evaluate to true. The operation effectively low-pass filters a very small neighborhood, typically 4×1 or 3×1, centered on and overwriting the artifact pixel. By restricting the filtering to a small neighborhood, the system is able to eliminate the artifacts while preserving the details in the synthesized view, without introducing undesired blurring. For other pixels in I_{P} that are not identified as a grid quantization artifact, I_{N} simply inherits the value of I_{P} at that pixel location.

Since lateral offsets are added in the horizontal direction, the described mechanism eliminates the vast majority of grid quantization artifacts. The remaining, less pronounced ones are reduced by a subsequent run of the same mechanism in the vertical direction.

The result, I_{N}, is a complete virtual view that is synthesized and contains no holes, with adjusted depth that suits a viewer's preference for depth. Quantization artifacts have also been modeled and removed.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

I/We claim:

1. A method for modifying a pair of stereoscopic images for presentation on a display comprising:
(a) receiving said pair of stereoscopic images;
(b) modifying different regions of at least one image of said pair of stereoscopic images in a manner such that the disparity of said different regions is changed;
(c) said modifying being selectable by a viewer among at least three different amounts of said disparity.

2. The method of claim 1 wherein said stereoscopic images are rectified with respect to one another.

3. The method of claim 1 further comprising determining said disparity between a first and a second one of said stereoscopic images.

4. The method of claim 1 wherein said different amounts substantially preserves the spatial variation of said different regions.

5. The method of claim 4 wherein a ratio of disparity values of said different regions remains substantially unchanged.

6. The method of claim 5 wherein said modification is based upon a scale value.

7. The method of claim 1 further comprising said modifying resulting in holes in a synthesized image that are subsequently filled.

8. The method of claim 7 wherein said filling is based upon inpainting.

9. The method of claim 7 wherein said filling is based upon a model of the surrounding intensity values proximate a respective said hole.

10. The method of claim 9 wherein said filling is based upon inward propagation.

11. The method of claim 10 wherein said filling is further based upon disparity values between said stereoscopic images.

12. The method of claim 11 wherein said filling is further based upon local geometric saliency.

13. The method of claim 12 wherein said filling is based upon different techniques for high frequency regions and low frequency regions.

14. The method of claim 7 further comprising a filter to reduce grid quantization artifacts.

15. The method of claim 14 wherein adaptive filtering is used to reduce grid quantization artifacts.

16. The method of claim 1 wherein said disparity modifications are based at least in part on the scene geometry of said stereoscopic images.

17. The method of claim 12 wherein said local geometric saliency is based upon a gradient.

18. The method of claim 1 wherein said modifying said different regions of said pair of stereoscopic images in a manner such that the disparity of said different regions further includes a constant offset.

19. The method of claim 6 wherein said scale is selectable among a substantially continuous range from a starting scale to an ending scale.

20. The method of claim 19 wherein said selectable range is automatic.

21. The method of claim 19 wherein said selectable range is as a result of an input selection from a user.
